(19) United States
(12) Patent Application Publication
(10) Pub. No.: US 2010/0220059 A1
(43) Pub. Date: Sep. 2, 2010

(54) Personal Recordation Device

(76) Inventor: Natalie Ann Barton, Mandeville, LA (US)

Correspondence Address: HARSHAW RESEARCH, INC., 210 W. TECUMSEH STREET, OTTAWA, KS, 66067, US

(21) Appl. No.: 12/394,277

(22) Filed: Feb. 27, 2009

(51) Int. Cl. G06F 3/02

(52) U.S. Cl. 345/168

(57) ABSTRACT

A personal recordation device includes a housing having first and second portions movable relative to one another. A keyboard coupled to the housing first portion and a display is coupled to the housing second portion. A processor is positioned in one of the housing portions and is in data communication with the keyboard and display. The device includes a memory device in at least one of the housing portions and is in data communication with the processor. The processor includes programming to cause data input through the keyboard to be stored in the memory device, and for the input data to be selectively organized in general pad, notepad, report, and engineering modes. In the general pad mode, input data is organized by date within a single file whereas in the notepad mode the input data is stored by date in a plurality of files.

### BACKGROUND OF THE INVENTION

This invention relates generally to writing and recording devices and, more particularly, to a digital notepad that enables a user to record text in various formats such as for note taking and report generation.

Laptop computers are often used in the classroom for note taking, report writing, and for organizing one's documents. In fact, traditional taking using a pencil and paper has become less popular due to a student's early familiarity with keyboarding skills and the realization that handwritten notes will likely need to be typed into a computer at a later time, utilized in typing a later report, and so on.

Although laptop computers are presumably effective for the tasks of note taking and report writing, they still require a significant investment of money and may be relatively large for use on the small desk typically found in a college classroom. In addition, laptop computers typically include nearly the full functionality of a home based personal computer, both in hardware and in software. This replication of the home computer on a slightly smaller scale adds to both the size and cost of the device, making the laptop less appropriate for student use in the classroom or truly portable in an educational environment.

Therefore, it would be desirable to have a portable digital notebook (a.k.a. a recordation device) that enables a user to digitally record notes in various formats appropriate to a context in which a user is receiving the information or desires to recall it at a later date. Further, it would be desirable to have a portable digital recordation device that may be personalized and that is functional in various lighting conditions. In addition, it would be desirable to have a portable digital recordation device that includes a full size keyboard while also being very portable, storable, and light weight.

### SUMMARY OF THE INVENTION

A personal recordation device according to a preferred embodiment of the present invention includes a housing having first and second portions movable relative to one another. The device includes a keyboard coupled to the housing first portion and a display coupled to the housing second portion. A processor is positioned in one of the housing first and second portions and is in data communication with the keyboard and the display. The recordation device includes a memory device in at least one of the housing first and second portions and is in data communication with the processor. The processor includes programming to cause data input through the keyboard to be stored in the memory device, and for the input data to be selectively organized in general pad, notepad, report, and engineering modes. In the general pad mode, input data is organized by date within a single file whereas in the notepad mode the input data is stored by date in a plurality of files.

Therefore, a general object of this invention is to provide a personal recordation device that enables a user to digitally record notes in a variety of formats for efficient use at a later date.

Another object of this invention is to provide a personal recordation device, as aforesaid, that selectively saves input data by data in different ways depending on mode.

Still another object of this invention is to provide a personal recordation device, as aforesaid, that can be personalized with interchangeable cover elements.

Yet another object of this invention is to provide a personal recordation device, as aforesaid, having a full sized QWERTY keyboard while still being relatively small and portable.

A further object of this invention is to provide a personal recordation device, as aforesaid, having a selectively illuminated or back-lit keyboard.

A still further object of this invention is to provide a personal recordation device, as aforesaid, in which data stored in different mode formats may be interrelated according to date.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a portable recordation device according to a preferred embodiment of the present invention illustrated in a closed configuration with a cover element released from selective attachment thereto;

FIG. 2 is a perspective view of the recordation device as in FIG. 1 in an open configuration;

FIG. 3 is a flowchart illustrating the logic performed by a processor of the recordation device according to the present invention; and

FIG. 4 is a block diagram illustrating the electronic components of the present invention.

### DESCRIPTION OF THE PREFERRED EMBODIMENT

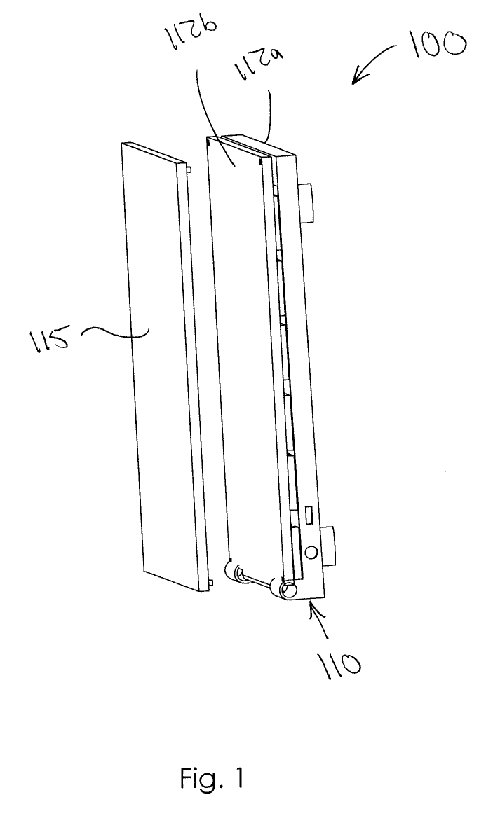

A personal recordation device will now be described in detail with reference to FIG. 1 through FIG. 4 of the accompanying drawings. More particularly, a personal recordation device (also referred to herein as a digital notepad) 100 of one embodiment includes a housing 110, a keyboard 120, a display 130, a processor 134, and a memory device 138.

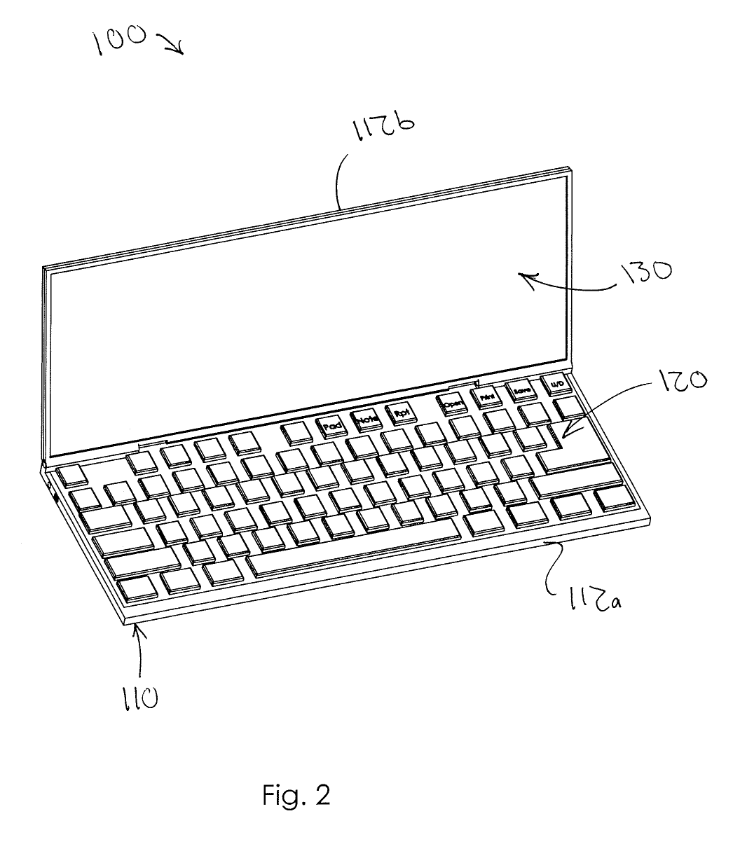

As shown in FIG. 2, the keyboard 120 and display 130 are coupled to the housing 110. The housing 110 may have first and second portions 112a, 112b movable relative to one another (e.g., rotatably or slidably), the keyboard 120 may be coupled to the first portion 112a, and the display 130 may be coupled to the second portion 112b. The first and second portions are, therefore, movable between open and closed configurations. A cover element 115 (FIG. 1) may be removably coupled to the housing second portion 112b such that the cover element 115 substantially covers the housing second portion 112b when coupled thereto.

The keyboard 120 may be a selectively backlit full size keyboard, and/or the keyboard 120 may be a QWERTY keyboard that further includes at least one programmable key. At least one key of the keyboard 120 may be a Greek letter key, and at least one key of the keyboard 120 may be a navigation key.

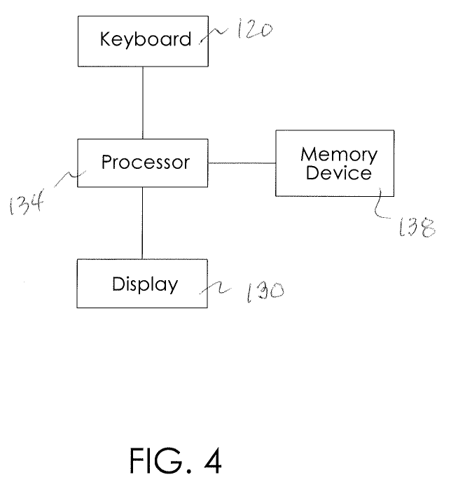

The processor 134 may be located in the housing 110 (e.g., in the first portion 112a and/or the second portion 112b ), and the memory device 138 may be located in the housing 110 (e.g. in the first portion 112a and/or the second portion 112b ). As shown in FIG. 4, the processor 134 is in data communication with the keyboard 120, the display 130, and the memory device 138.

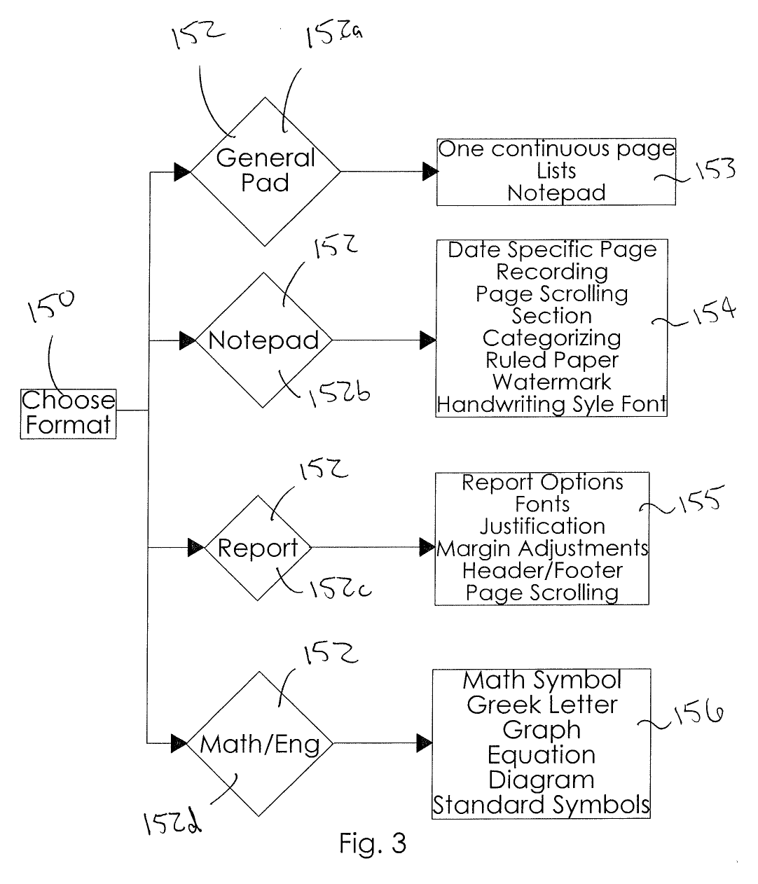

As shown in FIG. 3, there may be programming in the processor 134 to cause data input through the keyboard 120 to be stored in the memory device 138. Software in the processor 134, denoted by reference number 150, may allow a user to select between various modes 152 (e.g., a general pad mode 152a, a notepad mode 152b, a report mode 152c, and a math/engineering mode 152d), and specific keys on the keyboard 120 may allow the user to easily access the various modes 152. In the general pad mode 152a, programming in the processor 134 may cause data input through the keyboard 120 to be stored in the memory device 138 in at least one continuous page file, as shown by reference number 153. Programming may automatically (or upon prompting) relate one stored continuous page file with another continuous page file based on a time that the data stored in the first continuous page file was input through the keyboard 120 and a time that the data stored in the second continuous page file was input through the keyboard 120. For example, a file created on a Monday morning between 8:30 and 9:30 may be related to another file created on a different Monday morning between 8:30 and 9:30. This may be useful, for example, in accessing files related by schedule (e.g., class schedule, meeting schedule, etc.).

In the notepad mode 152b, programming in the processor 134 may cause data input through the keyboard 120 to be stored in a plurality of files identified by date, as shown by reference number 154. Programming may automatically (or upon prompting) relate one stored file identified by date with a second file identified by date based on a time that the data stored in the first file identified by date was input through the keyboard 120 and a time that the data stored in the second file identified by date was input through the keyboard 120, similar to the relating (or “associating”) routine described above regarding general pad mode 152a.

In the report mode 152c, programming in the processor 134 may allow data input through the keyboard 120 to be formatted by at least one of font type, font size, justification, and margin size and stored in the memory device 138, as shown by reference number 155. When in notepad mode 152b, files may be stored and identified by date, as in the notepad mode 152b, and those files may be related together as in the relating associating routines described above.

In the math/engineering mode 152d, programming in the processor 134 may cause at least some data input through the keyboard 120 to be stored in the memory device 138 in an equation format, as opposed to in standard lines of characters, as shown by reference number 156. When in the math/engineering mode 152d, files may be stored and identified by date, as in the notepad mode 152b, and those files may be related together as in the associating routines described above. In addition, this mode may allow data to be input in “layers” such that equations or special symbols may be added over the top of other regular text.

It should be appreciated that the associating routines may cross the various modes 152 and associate files from various modes together. For example, a file created while in the general pad mode 152a may be associated with a file created while in the math/engineering mode 152d. Programming in the processor 134 may allow a user to input a schedule (e.g., through the keyboard 120) to indicate which files should be associated with one another.

In use, the user may select the cover element 115 (FIG. 1) from various cover elements that have different designs, themes, etc., and may couple the cover element 115 to the housing 110 (e.g., through a snap fit interaction). The keyboard 120 may be used to select between the various modes 152, and data may be entered using the keyboard 120 and displayed on the display 130. If backlit, the keyboard 120 may be easily used in dark or poorly lit environments. As set forth above, files created to store the data input through the keyboard 120 may be related to one another in accordance with a schedule. The user may input the schedule using the keyboard 120, for example, and the processor 134 may automatically relate files to one another based on that schedule, or the user may prompt the processor 134 to save to a schedule in a non-automatic manner. The associations may allow files to be stored in a manner that is user-friendly and easily accessible, and may facilitate quick viewing and/or printing. The various modes 152 and ability to associate files in this way may be extremely beneficial to students and others with generally fixed schedules as this may provide efficient organization of files for study or review.

It is understood that while certain forms of this invention have been illustrated and described, it is not limited thereto except insofar as such limitations are included in the following claims and allowable functional equivalents thereof.

1. A personal recordation device, comprising:
a housing having first and second portions movable relative to one another;
a keyboard coupled to said housing first portion;
a display coupled to said housing second portion;
a processor in at least one of said housing first portion and said housing second portion, said processor being in data communication with said keyboard and said display; and
a memory device in at least one of said housing first portion and said housing second portion, said memory device being in data communication with said processor.

2. The device of claim 1, wherein said keyboard is a selectively backlit keyboard.

3. The device of claim 2, wherein said keyboard is a QWERTY keyboard that further includes at least one programmable key.

4. The device of claim 3, further comprising software in said processor for allowing a user to select between a general pad mode, a notepad mode, a report mode, and a math/engineering mode; wherein:
in said general pad mode, programming in said processor causes data input through said keyboard to be stored in said memory device in at least one continuous page file;
in said notepad mode, programming in said processor causes data input through said keyboard to be stored in a plurality of files identified by date;
in said report mode, programming in said processor allows data input through said keyboard to be formatted by at least one of font type, font size, justification, and margin size and stored in said memory device; and
in said math/engineering mode, programming in said processor causes at least some data input through said keyboard to be stored in said memory device in an equation format.

5. The device of claim 4, wherein a plurality of said files identified by date are associated together.

6. The device of claim 5, further comprising a cover element removably coupled to said housing second portion, said cover element substantially covering said housing second portion when coupled thereto.

7. The device of claim 6, further comprising:
programming in said processor to automatically relate a first said continuous page file with a second said continuous page file based on a time said data stored in said first continuous page file was input through said keyboard and a time said data stored in said second continuous page file was input through said keyboard; and
programming in said processor to automatically relate a first said file identified by date with a second said file identified by date based on a time said data stored in said first file identified by date was input through said keyboard and a time said data stored in said second file identified by date was input through said keyboard.

8. The device of claim 7, wherein said keyboard includes:
at least one Greek letter key; and
at least one navigation key.

9. The device of claim 1, further comprising software in said processor for allowing a user to select between a general pad mode, a notepad mode, a report mode, and a math/engineering mode; wherein:
in said general pad mode, programming in said processor causes data input through said keyboard to be stored in said memory device in a continuous page file;
in said notepad mode, programming in said processor causes data input through said keyboard to be stored in a plurality of files identified by date;
in said report mode, programming in said processor allows data input through said keyboard to be formatted by at least one of font type, font size, justification, and margin size and stored in said memory device; and
in said math/engineering mode, programming in said processor causes at least some data input through said keyboard to be stored in said memory device in an equation format.

10. The device of claim 9, further comprising:
programming in said processor to automatically relate a first said continuous page file with a second said continuous page file based on a time said data stored in said first continuous page file was input through said keyboard and a time said data stored in said second continuous page file was input through said keyboard; and
programming in said processor to automatically relate a first said file identified by date with a second said file identified by date based on a time said data stored in said first file identified by date was input through said keyboard and a time said data stored in said second file identified by date was input through said keyboard.

11. The device of claim 1, further comprising:
programming in said processor to cause data input through said keyboard to be stored in said memory device in a plurality of files; and
programming in said processor to automatically relate one said file with another said file based on a time said data stored in said first file was input through said keyboard and a time said data stored in said second file was input through said keyboard.

12. A personal recordation device, comprising:
a housing having first and second portions movable relative to one another;
a keyboard coupled to said housing first portion;
a display coupled to said housing second portion;
a processor in at least one of said housing first portion and said housing second portion, said processor being in data communication with said keyboard and said display;
a memory device in at least one of said housing first portion and said housing second portion, said memory device being in data communication with said processor; and
programming in said processor to cause data input through said keyboard to be stored in said memory device.

13. The device of claim 12, further comprising software in said processor for allowing a user to select between a general pad mode and a notepad mode; wherein:
in said general pad mode, said programming causes data input through said keyboard to be stored in said memory device in at least one continuous page file; and
in said notepad mode, said programming causes data input through said keyboard to be stored in a plurality of files identified by date.

14. The device of claim 13, further comprising:
programming in said processor to automatically relate a first said continuous page file with a second said continuous page file based on a time said data stored in said first continuous page file was input through said keyboard and a time said data stored in said second continuous page file was input through said keyboard; and
programming in said processor to automatically relate a first said file identified by date with a second said file identified by date based on a time said data stored in said first file identified by date was input through said keyboard and a time said data stored in said second file identified by date was input through said keyboard.

15. The device of claim 14, further comprising a cover element removably coupled to said housing second portion, said cover element substantially covering said housing second portion when coupled thereto; wherein:
said keyboard is a selectively backlit keyboard; and
said keyboard is a QWERTY keyboard that further includes at least one programmable key.

16. The device of claim 12, further comprising a cover element removably coupled to said housing second portion, said cover element substantially covering said housing second portion when coupled thereto.

17. A digital notepad, comprising:
a housing;
a keyboard coupled to said housing;
a display coupled to said housing;
a processor in said housing, said processor being in data communication with said keyboard and said display;
a memory device in said housing, said memory device being in data communication with said processor; and
programming in said processor to cause data input through said keyboard to be stored in said memory device.

18. The digital notepad of claim 17, further comprising software in said processor for allowing a user to select between a general pad mode, a notepad mode, a report mode, and a math/engineering mode; wherein:
in said general pad mode, said programming causes data input through said keyboard to be stored in said memory device in at least one continuous page file;
in said notepad mode, said programming causes data input through said keyboard to be stored in a plurality of files identified by date;
in said report mode, said programming allows data input through said keyboard to be formatted by at least one of font type, font size, justification, and margin size and stored in said memory device; and
in said math/engineering mode, said programming causes at least some data input through said keyboard to be stored in said memory device in an equation format.

19. The digital notepad of claim 18, further comprising:
programming in said processor to automatically relate a first said continuous page file with a second said continuous page file based on a time said data stored in said first continuous page file was input through said keyboard and a time said data stored in said second continuous page file was input through said keyboard; and
programming in said processor to automatically relate a first said file identified by date with a second said file identified by date based on a time said data stored in said first file identified by date was input through said keyboard and a time said data stored in said second file identified by date was input through said keyboard.

20. The digital notepad of claim 17, wherein said programming causes data input through said keyboard to be stored in said memory device in a plurality of files; and further comprising programming in said processor to automatically relate one said file with another said file based on a time said data stored in said first file was input through said keyboard and a time said data stored in said second file was input through said keyboard.
